(19) United States
(12) Patent Application Publication
(10) Pub. No.: US 2005/0287357 A1
(43) Pub. Date: Dec. 29, 2005

(54) Light diffusion sheet with high surface hardness and method of manufacturing the same

(76) Inventors: Jyh Horng Wang, Sansia Township (TW); Jen Huai Chang, Yongjing Shiang (TW); Kai-Hsin Lee, Jhongli City (TW); Wei-Ming Chiu, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/926,970

(22) Filed: Aug. 27, 2004

(30) Foreign Application Priority Data
Jun. 24, 2004 (TW) 093118260

(51) Int. Cl. B32B 5/16; B28B 1/00

(52) U.S. Cl. 428/323; 264/614; 264/638

(57) ABSTRACT

A light diffusion sheet with high surface hardness and method of manufacturing the same is used in the backlight of liquid crystal display and is made by multi-player plastic co-extrusion technology, which can produce light diffusion sheet structure of a plurality layers. The structure is to propose at least a high surface hardness layer on the light diffusion sheet as producing backlight module with direct light of liquid crystal display so as to achieve the resistance to scratch. Therefore, it can prevent from the scratch caused by the hardness stuffs such as fingers, dust, module frame, and so on in the assembling, delivery, or packing processes, and further facilitate the mass production, reduce the manufacturing cost, and increase the yield ratio of assembling significantly.

### BACKGROUND OF THE INVENTION

1. Field of the Invention

The present invention relates to a light diffusion sheet with high surface hardness and method of manufacturing the same. Therein, the light diffusion sheet with high surface hardness and method of manufacturing the same especially made by co-extrusion technology.

2. Description of the Related Art

Accordingly, coming of the digital times, digital TV will prevail in the world around at 2006, and at that time, there shall be a great mass fervor of replacement TV. In perspective, the dominant stream of future digital TV will be TFT-LCD TV, PDP TV and rear projective TV. Wherein, the TFT-LCD TV has the most chance to take dominant in the market. However, there are still many problems waiting to be conquered now. Except to the shortened reactive time, the enhancement of resolution, and the acceptable rate of large dimension panel, the advancement of brightness of backlight module is also one of the prominent directions as well.

To advance the brightness of the liquid crystal display, it is inevitable to increase the number of cold cathode fluorescent lamp (CCFL) as well as to change the original edge light into directly light. As show in FIG. 1, which is the preferred embodiment of backlight module structure with directly light in conventional art, therein, the backlight module of directly light includes a reflector 10′, a plurality of light sources 20′, and a diffusion sheet 30′. In addition, to avoid the trace of lamp being spotted directly, it is necessary to change into diffusion sheet instead of light guide panel so as to spread the brightness of light uniformly. So far, the thickness of diffusion sheet is contained at 1˜3 mm, and in contrary, the light guide panel is controlled at 2˜12 mm. Therefore, there is space to cost down the material cost, and also to achieve the purpose of thinness. The present diffusion sheet is made of the material such as polymethyl methacrylate (PMMA), methyl methacrylate/styrene copolymer (MS), polycarbonate (PC), PS, ABS, PETG, and Cycle Olefin Copolymer (COC). Besides, the light diffusion particles are added into the transparent based material so as to achieve the uniformity of the diffusion light.

No matter the light diffusion sheet is formed of which kind of materials, its surface hardness is poor, which contributes to the frequent scratches caused by the fingers of the operators, dust, the frame of the modules, or the metal or solid stuffs in the process of cutting, packing, or assembling. Example, PC diffusion sheet, its surface pencil hardness is mere 2B, and even the PMMA or MS are only 2H. To conquer this question, generally the light diffusion sheet would be coated with a layer of thermosetting or photo-curing resin at the thickness of 2-50 um. The coating processes mainly include sputtering, roller coating, dipping, and dripping to apply a resin with resistance to scratch, and the frequently coated materials cover the combinations of monomers, including PU monomer, acrylate monomer, epoxy monomer, or polyester, and so on. Under the thermal, photo, or electron beam curing method, the polymerizing would form a film layer with resistance to scratch. In addition, the addition antistatic agent can also be considered to manage the antistatic function as well as the UV absorbent is added to block the UV light so as to achieve the protective function for light diffusion sheet. Besides, the main difficult point of wet coating comes from that the quality of product would be significantly influenced by the recipe of material, coating procedure and apparatus, operating environment, and process parameter, which cause the drawback of low yield ratio.

Therefore to propose a novel light diffusion sheet with high surface hardness and method of manufacturing the same to the above-mentioned problems, not only can improve the failure of the coating process in the conventional art, but also has been the continuous expectation and concern of the inventor. Based on the engagement in the research, development, and practical sales experience on the related products for many years, the idea of invention has been in embryo, and finally, a kind of light diffusion sheet with high surface hardness and method of manufacturing the same have been figured out via the dedicated personal professional knowledge, study and design.

### SUMMARY OF THE INVENTION

The purpose of the present invention is to offer an light diffusion sheet with high surface hardness and method of manufacturing the same, wherein the used light diffusion sheet is applied with a high surface hardness layer to manage resistance to scratch so as to prevent the scratches caused by the solid stuff such as finger, dust, the frame of module, and so on in the process of assembling, delivery, or packing, thus securing the mass production, decreasing the manufacturing cost and, increasing the yield ratio of module assembling.

The second purpose of the present invention is to offer a light diffuse sheet with high surface hardness and method of manufacturing the same, wherein the addition of antistatic agent can be considered in recipe of light diffuse sheet so as to manage the additional antistatic function.

The third purpose of the present invention is to offer a light diffuse sheet with high surface hardness and method of manufacturing the same. Therein the addition of UV absorbent can be included in the light diffusion sheet to block the UV light from radiating to the light diffuse sheet directly so as to prevent the phenomena such as degradation and fragmentation, hence conquering the deviation due to the degradation of light diffusion sheet in color temperature and chromaticity of liquid crystal display. Therefore, it is possible to advance the product quality and increase the life of material.

To achieve the above-mentioned purposes and advantages, the present invention is to offer an light diffusion sheet with high surface hardness and method of manufacturing the same, wherein the light diffusion sheet is applied in the backlight module of liquid crystal display, and the multi-layer co-extrusion technology is utilized to produce the light diffusion sheet of liquid crystal display. It is regarded in the present invention that as manufacturing the light diffusion sheet of direct light module necessary for the TFT-LCD TV, at least a high surface hardness layer is set on the surface of light diffusion sheet so as to manage resistance to scratch and prevent from the scratches caused by the finger, dust, or module frame, and so on in the assembling, delivery, or packing processes. Therefore, the mass production, reduced manufacturing cost, and high yield ratio of module assembling can be managed. In the production technology, the polymer co-extrusion technology is utilized to produce the light diffusion sheet of multi-layer structure. And basically, the based material is added with the material of light diffuser layer, and the transparent resin with high surface hardness is co-extruded out by 10-500 um from at least a surface of the light diffusion sheet such as the poly-methyl methacrylate (MMA) resin and copolymer at the same time to form at least a surface of hardness film layer resistant to scratch on the light diffusion sheet, thus constructing a light diffusion sheet with at least a surface of high surface hardness.

### BRIEF DESCRIPTION OF THE DRAWING

FIG. 1 refers to the backlight module structure with direct light in the conventional art.

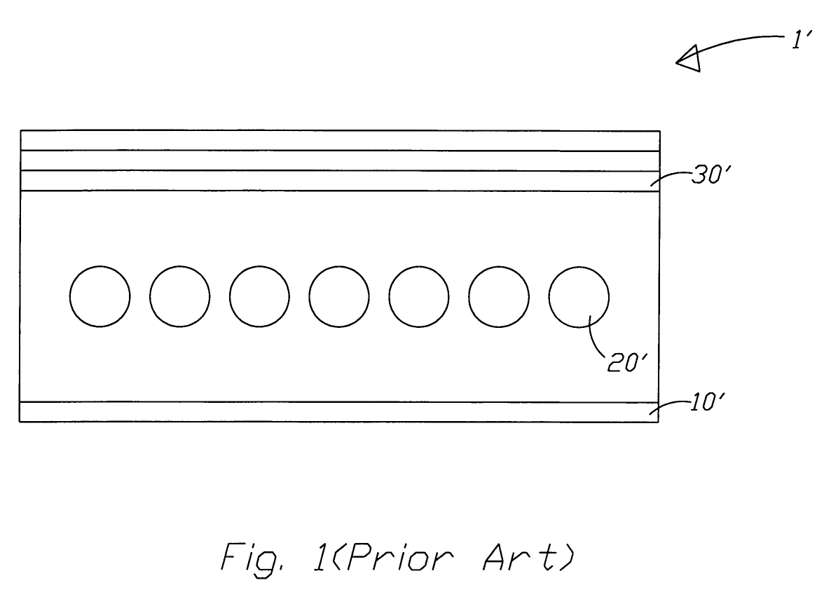

FIG. 2 refers to the preferred embodiment of light diffusion sheet structure of backlight module with direct light of the liquid crystal display in the present invention.

FIG. 2A refers to another preferred embodiment of light diffusion sheet structure in the present invention.

FIG. 3 refers to a preferred embodiment of light diffusion sheet manufacturing process in the present invention, and

FIG. 4 refers to the preferred embodiment of light diffusion sheet manufacturing flowchart picture in the present invention.

### DETAILED DESCRIPTION OF THE PREFERRED EMBODIMENT

To have a further understanding about the features of the structure and the achieved effects, of the present invention, the preferred embodiment and detailed description are unfolded as following.

To improve the problem of scratch of light diffusion sheet of backlight module with direct light in the liquid crystal display in the conventional art, the high surface hardness layer is proposed in the present invention, wherein the anti-UV absorbent is added and the thickness of high surface hardness layer is contained at 100 μm. In addition, a co-extrusion is also proposed in the present invention. As the light diffuser layer is formed by the main extruder, the high surface hardness layer mixed with anti-UV absorbent is also offered by the sub-extruder at the same time, thus co-extrusion on at least a surface of the light diffuser layer so as to achieve the high hardness of surface and conquer the problem of degradation caused by the direct radiation to the light diffuser layer of the UV light.

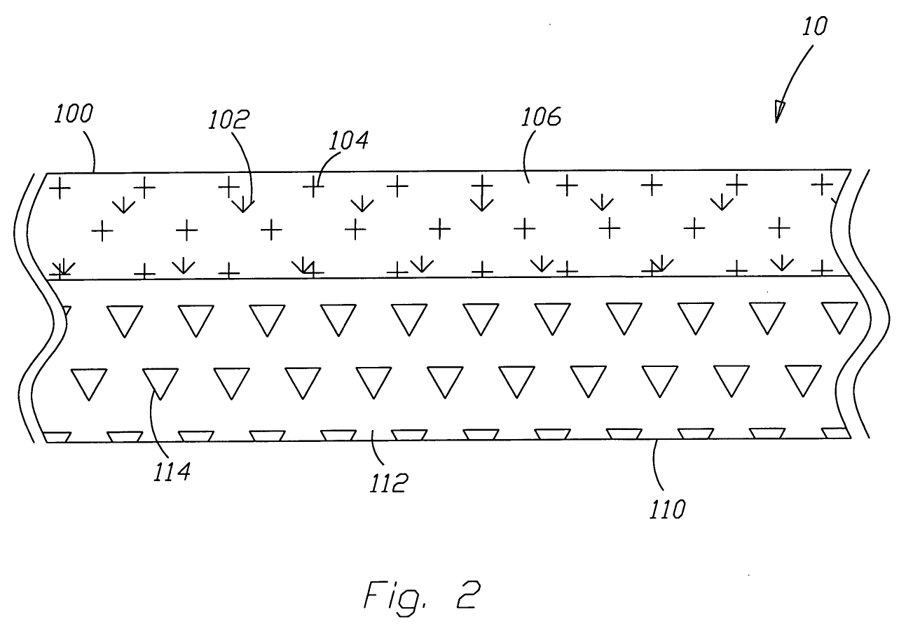

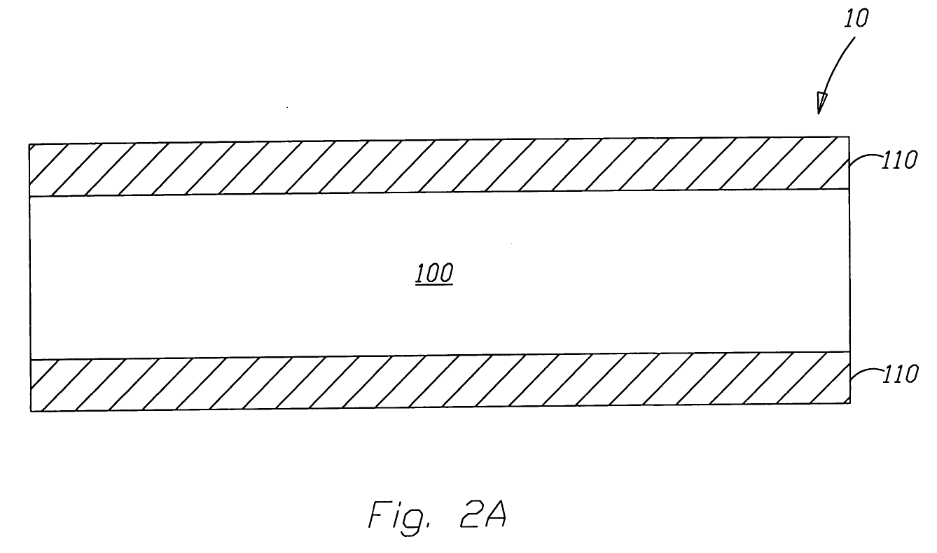

FIG. 2 is the preferred embodiment of light diffusion sheet structure of backlight module with direct light in the liquid crystal display in the present invention, wherein the present invention is related to a kind of light diffusion sheet structure with high surface hardness layer. And the light diffusion sheet structure 10 comprises: a least a high surface hardness layer 100, which can be mixed with an antistatic agent 102 and an anti UV absorbent 104, and a light diffuser layer 110, wherein the high surface hardness layer 100 is on at least a surface of the light diffuser layer 110, and the high surface hardness layer 100 has resistance to scratch to prevent the scratch phenomena of light diffusion sheet caused by the hardness stuff such as finger, dust, or frame in the process of assembling, delivery, or packing so as to facilitate the mass production reduce the manufacturing cost, and advance the yield ratio of assembling significantly.

Wherein the high surface hardness layer 100 comprises: a resin 106 and other admixtures such as the antistatic agent 102 and the anti UV absorbent 104. The resin 106 is chosen from the group consisting of acrylate, PMMA, MS, PC, m-COC, PETG, PS and etc, and the high surface hardness layer 100 is at thickness of 1-200 μm. The light diffuser layer 110 comprises a plurality of light diffusing particles 114 and a based material 112, wherein the light diffusing particle 114 is selected from the organic material or inorganic material such as acrylate, silicon, polystyrene, titanium dioxide, silicon dioxide, and etc, and the based material 112 is selected from acrylate, PMMA, MS, and PC.

Moreover as shown in FIG. 2A, which is related to another preferred embodiment of light diffusion sheet structure, wherein the light diffusion sheet 10 of the present invention can be set with a high surface hardness layer 100 on the up and bottom sides.

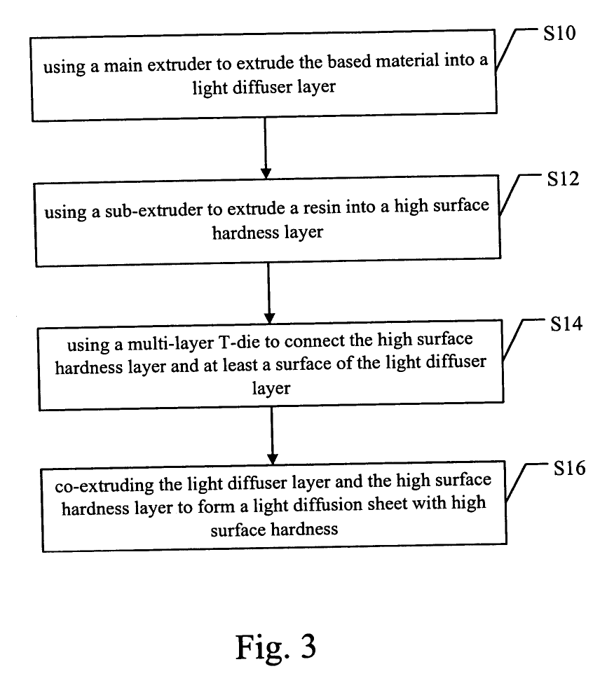

Furthermore, as shown in FIG. 3, which is the preferred embodiment of light diffusion sheet manufacturing process in the present invention, wherein the manufacturing method of the light diffusion sheet with high surface hardness of backlight module with direct light mainly comprises:
Step S10: using a main extruder to extrude the based material into a light diffuser layer.
Step S12: using a sub-extruder to extrude a resin into a high surface hardness layer.
Step S14: using a multi-layer T-die to connect the high surface hardness layer and at least a surface of the light diffuser layer, and
Step S14: co-extruding the light diffuser layer and the high surface hardness layer to form a light diffusion sheet with high surface hardness.

In step S10, the light diffuser layer comprises a plurality of light diffusing particles, which contains 10% of the based material. And in step S12, the high surface hardness layer includes an admixture of anti-UV absorbent, which stands 1% of the resin.

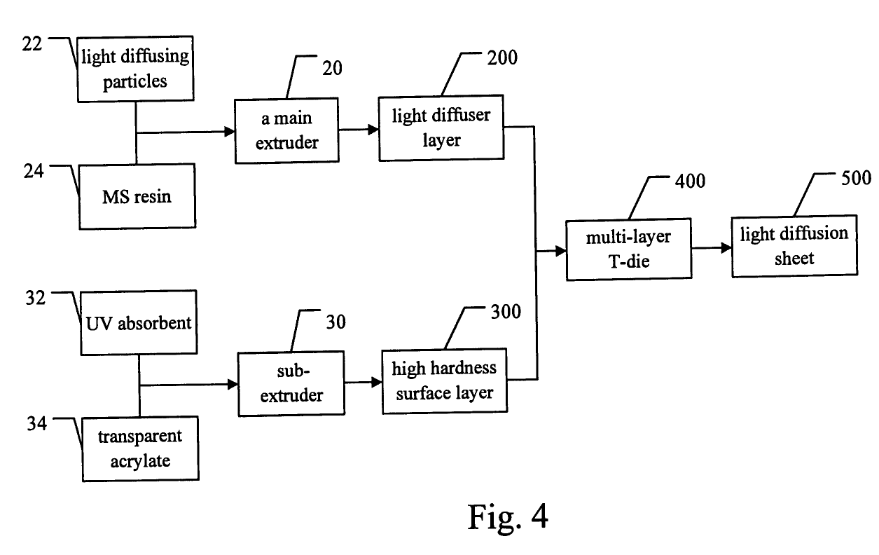

Finally, FIG. 4 refers to the preferred embodiment of light diffusion sheet manufacturing flowchart picture. In the figure, the light diffusion sheet in the present invention mainly adopts a main extruder 20 to extrude a light diffuser layer 200 of MS resin 24 (MMA and styrene monomer copolymer) added with the light diffusing particles 22 mixed with 10% of PMMA. And a sub-extruder 30 is utilized to extrude a transparent acrylate 34 mixed with 1% of UV absorbent 32 into a high surface hardness layer 300 to get the anti-UV function. Via multi-layer T-die 400, the high hardness surface layer 300 is connected to at least a surface of the light diffuser layer 200, thus the light diffuser layer 200 and the anti-UV high surface hardness layer 200 is co-extruded into an light diffusion sheet 500 with plate structure of high surface hardness, resistance to degradation, and high dimension stability.

Therefore, the present invention is related to a kind of light diffusion sheet and method of manufacturing the same, wherein the light diffusion sheet refers to the one, which is used in the backlight module in the liquid crystal display. In addition, the multi-layer co-extrusion technology is utilized to produce the light diffusion sheet of multi-layer structure. As producing the light diffusion sheet of backlight module with direct light in the liquid crystal display, a high surface hardness layer is also applied on the surface of the light diffuser player at the same time to facilitate the resistance to scratches so as to prevent the scratch phenomena on the light diffusion sheet cause by the hardness stuffs such as finger, dust, module frame, and etc. in the assembling, delivery, and packing processes, thus facilitating mass production, reduce manufacturing cost, and increasing the yield ratio of module assembling significantly.

In conclusion, this invention definitely achieves creativity, improvement, and more usability for the users in the industry. This being the case, it should be qualified for the patent applications in the intellectual patent regulation of our country, thus being proposed for the approval of the patent. Looking forward to the kind rendering of the approval at the earliest convenience.

The above-mentioned practice is only a preferred embodiment of this invention, not the specified limit of it. All the parallel changes and revisions of the shape, the structure, the feature, and the spirit evolving from this invention should be included in the field of the claimed patent of this invention.

1. A method of manufacturing the light diffusion sheet with high surface hardness comprising the steps:
using a main extruder to extrude a based material into an light diffuser layer;
using a sub-extruder to extrude a resin and form a high surface hardness layer;
using a multi-layer T-die to connect said high surface hardness layer with at least a surface of said light diffuser layer; and
co-extruding said light diffuser layer and said high surface hardness layer to form a light diffusion sheet with high surface hardness.

2. A structure of light diffusion sheet with high surface hardness, wherein the structure comprising:
a light diffuser layer; and
a high surface hardness layer;
wherein said multi-layer T-die is utilized to co-extrude said light diffuser layer and said high surface hardness layer to form an light diffusion sheet with high surface hardness.

3. The structure as claimed in claim 2, wherein said light diffuser layer comprises a based material and a plurality of light diffusing particles.

4. The structure as claimed in claim 3, wherein said based material is the one selected from the group consisting of PMMA, MS, PC, m-COC, PETG, PS and etc.

5. The structure as claimed in claim 3, wherein said light diffusing particle is selected from the organic material or inorganic material.

6. The structure as claimed in claim 5, wherein said light diffusing particle is the one selected from the group consisting of acrylate, silicon, polystyrene, MS, titanium dioxide, and silicon dioxide.

7. The structure as claimed in claim 3, wherein the included content of said a plurality of light diffusing particles contains 10% of said based material.

8. The structure as claimed in claim 2, wherein said high surface hardness layer includes a resin and an anti-UV absorbent.

9. The structure as claimed in claim 8, wherein said resin is the one selected from the group consisting of transparent acrylate, PMMA, MS, m-COC, and PC, PETG, PS.

10. The structure as claimed in claim 8, wherein the included content of said UV absorbent contains 0.01-5% of said resin.

11. The structure as claimed in claim 2, wherein the thickness of said high surface hardness layer is 1-200 μm.
